(19) United States
(12) Patent Application Publication
(10) Pub. No.: US 2022/0280899 A1
(43) Pub. Date: Sep. 8, 2022

(54) METHOD FOR PURIFYING HIGH MOLECULAR WEIGHT ADENOSINE-BASED COENZYMES BY TANGENTIAL DIAFILTRATION

(71) Applicant: Institut des Sciences et Industries du Vivant et de I'environnement - Agroparis Tech, Paris Cedex 05 (FR)

(72) Inventors: Louis Mouterde, Reims (FR); Gaelle Willig, Reims (FR); Florent Allais, Bouy (FR)

(21) Appl. No.: 17/597,418

(22) PCT Filed: Jul. 9, 2020
(86) PCT No.: PCT/FR2020/051244

§ 371 Date: Jan. 5, 2022

(30) Foreign Application Priority Data
Jul. 11, 2019 (FR) FR1907798

(51) Int. Cl. B01D 61/14; B01D 71/56; B01D 71/68

(52) U.S. Cl. CPC B01D 61/145; B01D 71/56; B01D 71/68; B01D 2311/04; B01D 2311/263; B01D 2315/10; B01D 2315/16; B01D 2325/20

(57) ABSTRACT

The present disclosure relates to the field of making high molecular weight adenosine-based coenzymes available on a large scale. In particular, it relates to a method for purifying high molecular weight adenosine-based coenzymes by implementing a tangential diafiltration, or even dia-ultrafiltration step. This method is, for example, applicable to the purification of coenzyme A disulfide ((CoAS)₂), coenzyme A (CoA), nicotinarnide adenine dinucleotide (NAD+), nicotinarnide adenine dinucleotide phosphate (NADP⁺) or flavin adenine dinucleotide (FAD).

### CROSS-REFERENCE TO RELATED APPLICATIONS

This application is a national phase entry under 35 U.S.C. § 371 of International Patent Application PCT/FR2020/051244, filed Jul. 9, 2020, designating the United States of America and published as International Patent Publication WO 2021/005314 A1 on Jan. 14, 2021, which claims the benefit under Article 8 of the Patent Cooperation Treaty to French Patent Application Serial No. FR1907798, filed Jul. 11, 2019.

### TECHNICAL FIELD

The present disclosure relates to the field of large-scale provision of high molecular weight adenosine-based coenzymes. It relates, in particular, to a method for purifying high molecular weight adenosine-based coenzymes, implementing a tangential diafiltration, or indeed dia-ultrafiltration, step. This method is, for example, applicable to the purification of coenzyme A disulfide ((CoAS)₂), coenzyme A (CoA), nicotinamide adenine dinucleotide (NAD⁺), nicotinamide adenine dinucleotide phosphate (NADP⁺) or flavin adenine dinucleotide (FAD).

### BACKGROUND

The attempts at developing more ecological enzymatic methods are hampered by several limitations. The main one relates to the accessibility to the coenzymes, on which some enzymes depend in order to catalyze the reactions.

The current methods for preparing high molecular weight adenosine-based coenzymes comprise a step of chromatography purification. This is the only known method that makes it possible to separate the high molecular weight adenosine-based coenzymes from a lower molecular weight adenosine-based coenzyme, adenosine triphosphate (ATP), as well as adenosine diphosphate (ADP) and adenosine monophosphate (AMP) nucleotides. The yield of such a step is very low, and consequently the cost is very high. Moreover, this method involves the use of solvents that are harmful to the environment.

On account of the very high cost of some coenzymes, many enzymatic reactions are implemented by means of biosynthesis rather than by a synthetic in vitro approach, but the limitation of this approach is in the acceptability of the substrate for the microorganisms used. Moreover, it is not possible to prepare any desired molecule in this way.

An example of a coenzyme of interest for several enzymatic reactions is coenzyme A (CoA). This coenzyme comes at a cost of $2160/gram for a purity of approximately 85%. Moreover, on account of the free thiol function thereof, this molecule is not particularly stable at pH values of from 6 to 14, which makes the large-scale preparation thereof difficult, since the enzymes required for the preparation thereof are active in this pH range.

In order to overcome these problems of stability, a chemo-enzymatic approach, allowing for large-scale preparation of a CoA dimer, coenzyme A disulfide ((CoAS)₂), has been developed (Mouterde L. et al., Org. Process Res. Dev. 2016, 20 (5) 954-959). By virtue of this method, it is possible to access CoA by simply reducing the CoA dimer using a disulfide bridge reducer. This dimeric molecule is also commercially available, but at a very high price, in the region of $31600/gram. The high cost of the CoA and of (CoAS)₂ is primarily due to the purification methods, as set out above. By way of example, one of the most economical methods that can be found in the literature uses 1.8 liters of an aqueous solution of LiCl at 300 mM, 1.2 liters of an aqueous solution of LiCl at 600 mM, 1 liter of an aqueous solution of 40% acetone (v/v) containing 0.028% hydroxylamine in order to purify 1.9 gram of (CoAS)₂.

Even though this in vitro preparation method makes the (CoAS)₂ molecule accessible at the scale of the gram, the problem of the cost of the purification remains. This explains why the cofactor CoA is underexploited compared with the numerous possible applications.

This problem is the same for other high molecular weight adenosine-based coenzymes, such as nicotinamide adenine dinucleotide (NAD⁺) ($173/gram), nicotinamide adenine dinucleotide phosphate (NADP⁺) ($802/gram), and flavin adenine dinucleotide (FAD) ($383/gram), of which adenosine triphosphate (ATP), adenosine diphosphate (ADP), and adenosine monophosphate (AMP) are co-products of biosynthesis.

Various documents describe a method in which a high molecular weight adenosine-based coenzyme is retained by virtue of membrane filtration; however, the aim of these documents is the purification of products of an enzymatic reaction taking place in the retentate (conversion medium, fermentation medium, etc.). The retentate thus contains the coenzyme, but also the enzyme, and other molecules, in a heterogeneous medium (WO2008/144792; Drioli et al. (1996), Rolf Winchmann et al. (1981), DE 10 2004 002259).

To date, there is a real need to make different high molecular weight adenosine-based coenzymes available, at a large scale and an affordable price.

### BRIEF SUMMARY

The present disclosure relates to a method for purifying a high molecular weight adenosine-based coenzyme by implementing a tangential diafiltration.

In a preferred embodiment of the disclosure, the purified molecule is a CoA dimer, coenzyme A, or NADP⁺ (FIG. 1).

The purification method according to the disclosure has several advantages, as disclosed in the following.

The inventors have provided proof of concept of the significance of this method for purifying CoA dimer, the oxidized form of a cofactor of great interest, by separating it from a lower molecular weight adenosine-based cofactor, adenosine triphosphate (ATP), and adenosine diphosphate (ADP) and adenosine monophosphate (AMP) nucleotides present in solution. Screening of different membranes has revealed the non-obvious nature with regard to the separation of these molecules, which are of a similar physico-chemical nature and only somewhat different molecular weights.

Recently, one of the inventors has developed a novel method for in vitro synthetic synthesis of CoA dimer (Mouterde L. et al., Org. Process Res. Dev. 2016205954-959) that makes possible large-scale preparation of this dimer. However, to date this has not been exploited, owing to a lack of an industrializable purification method. Research has been pursued as far as developing the method according to the disclosure, which resolves this problem and opens the way for industrial exploitation of CoA, which is the limiting element in numerous projects that have remained, for this reason, at the stage of proof of concept in the laboratory.

This industrializable method is of a “lasting and green” nature, reinforced by the following facts:
it is preferably carried out in the absence of any organic solvent;
the considerable reduction in the volume of salts used: this method makes it possible to substitute lithium chloride buffer solutions (300 and 600 mM), organic solvents (such as acetone), and other chemical compounds (such as hydroxylamine), with milli-Q water;
it is a “2 in 1” method, in which the purification and the “desalting” are carried out in a single step;
the washing water can be recycled and reintroduced into the method.

This method can be used to purify all high molecular weight adenosine-based coenzymes, such as nicotinamide adenine dinucleotide (NAD⁺), nicotinamide adenine dinucleotide phosphate (NADP⁺), or flavin adenine dinucleotide (FAD), by separating them from the co-products of their biosynthesis (small charged or non-charged molecules, but also ATP, ADP and AMP).

The tangential diafiltration is also advantageous in that it limits the clogging and increases the service life of the membranes, compared with frontal diafiltration. Thus, the frequency for replacing the membrane is reduced.

The method provides the possibility of carrying out the purification of the coenzyme at a large scale.

By virtue of the numerous advantages thereof, this method opens the way for large-scale use of in vitro enzymatic reactions requiring the use of high molecular weight adenosine-based coenzyme.

### BRIEF DESCRIPTION OF THE DRAWINGS

FIG. 1: Structures of (CoAS)₂, CoA and NADP⁺

FIG. 2: HPLC range of (CoAS)₂

FIG. 3: Filtration pilot according to a closed-circuit tangential configuration

FIG. 4: HPLC range of NADP⁺

FIG. 5: Tangential diafiltration pilot

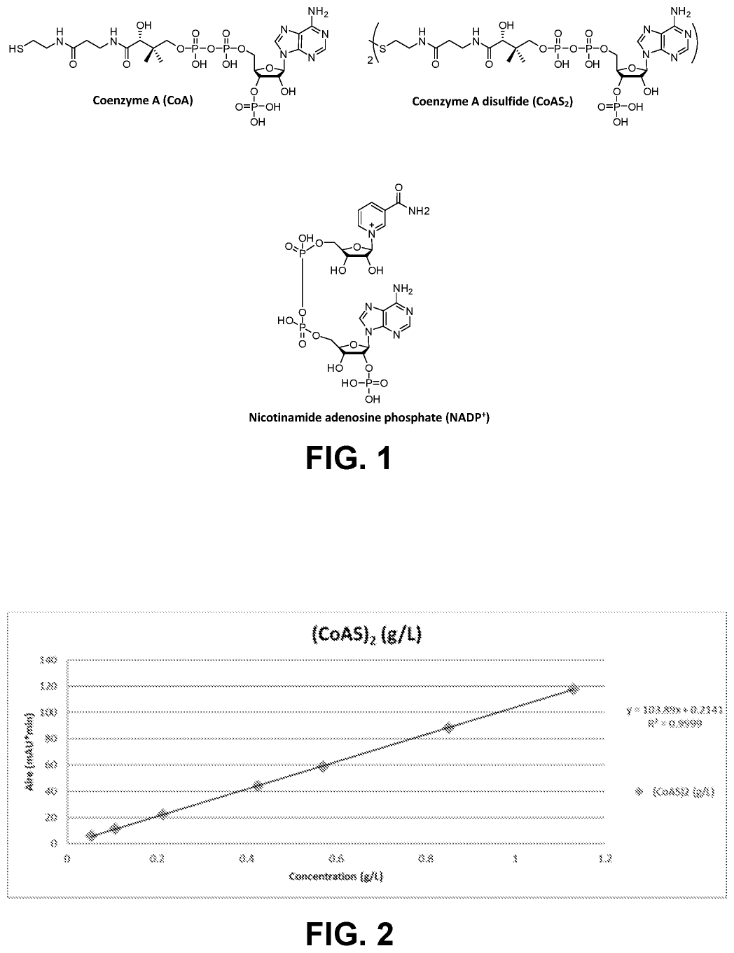

### DETAILED DESCRIPTION

In a first aspect, the present disclosure relates to a method for purifying a high molecular weight adenosine-based coenzyme by implementing a tangential diafiltration.

Thus, by virtue of the diafiltration, the coenzyme of interest is retained, while the smaller molecules, which are coproducts of the coenzyme synthesis process, are eliminated in the permeate.

In a preferred embodiment of the disclosure, the filtration is a dia-ultrafiltration.

“Coenzyme” means a cofactor that is required for the activity of an enzyme (protein). A coenzyme is a non-protein organic molecule. The high molecular weight adenosine-based coenzymes include coenzyme A dimer (coenzyme A disulfide or (CoAS)₂), coenzyme A (CoA) or the derivatives thereof, nicotinamide adenine dinucleotide (NAD⁺), nicotinamide adenine dinucleotide phosphate (NADP⁺), or flavin adenine dinucleotide (FAD). Within the meaning of the disclosure, a high molecular weight coenzyme is a compound of which the molecular weight is greater than or equal to 600 Da.

In a preferred embodiment of the disclosure, the high molecular weight adenosine-based coenzyme is a coenzyme A dimer.

In another preferred embodiment of the disclosure, the high molecular weight adenosine-based coenzyme is coenzyme A or one of the derivatives thereof.

Within the meaning of the disclosure, “derivatives of coenzyme A” means a compound of formula (I):

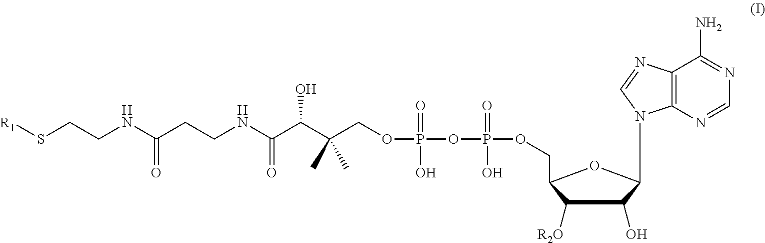

in which:
R₁ represents a C₁ to C₂₂ linear, cyclic or branched, saturated or unsaturated, acyl group, with or without a carboxylic acid, alcohol and/or amine group in the terminal position, or branched; a C₁ to C₂₂ linear, cyclic or branched, saturated or unsaturated, alkyl group, with or without a carboxylic acid, alcohol and/or amine group in the terminal position, or branched; a benzoyl or benzyl group
R₂ represents an H or a phosphate group.

In another preferred embodiment, the high molecular weight adenosine-based coenzyme is NADP⁺.

In the case of the coenzyme A, on account of a stability problem during the preparation thereof, it is preferable to prepare a CoA dimer, i.e., CoA disulfide ((CoAS)₂). Indeed, the CoA must be stored at −20° C., while the CoA dimer can be kept at ambient temperature. A simple disulfide bridge reduction reaction makes it possible to obtain CoA. Reducing agents suitable for this reaction are, for example, 2-mercaptoethanol, DTT or TCEP. It is also possible to carry out this reduction by means of biocatalysis, using a CoA disulfide reductase.

The purification method according to the disclosure has the dual advantage of being inexpensive and ecological. Indeed, it is based on the implementation of diafiltration carried out on an aqueous buffer solution, which can be purified using deionized water, or any other aqueous buffer solution. The solution that allows for the purification may be selected depending on the coenzyme to be purified and on the material of the membrane. A person skilled in the art would be able to make this choice based on his general knowledge.

The material of the membrane is selected depending on the coenzyme to be purified. This is preferably a filtration membrane.

The diafiltration is preferably carried out in the absence of an organic solvent, and, on the contrary, in the presence of an aqueous solvent, preferably an aqueous buffer solution, in particular, with water, such as deionized water.

In a preferred embodiment, the membrane used is made of a polymer of the polyethersulfone (PES) type, or a modified polyamide (such as provided by the suppliers), and the solution allowing for the purification is deionized water. These parameters are applicable, in particular, for purifying a CoA dimer, coenzyme A, and NADP⁺.

As mentioned above, a high molecular weight coenzyme according to the disclosure is a compound of which the molecular weight is greater than or equal to 600 Da.

Thus, with the aim of purifying high molecular weight adenosine-based coenzymes, the cut-off of the membrane makes it possible to retain the coenzymes of which the molecular weight is greater than or equal to 600 Da. It should be noted that the cut-off of the membranes stated by the manufacturers does not necessarily reflect the reality, and that other factors such as the conformation of the compound, the chemical functions present (in particular, when they are charged), and the membrane-compound interactions, may influence whether or not the compound passes through the membrane. For information, the molecular weight of the CoA dimer is in the region of 1500 Da, and that of the CoA and NADP⁺ is in the region of 750 Da.

A functional definition of a membrane according to the present disclosure is that the membrane must allow the passage of the molecules having a molecular weight of less than 600 Da, while retaining the coenzyme of interest.

The principle of membrane filtration involves applying a motive transfer force, in this case a pressure difference, to the membrane, in order to carry out the separation. Within the context of the present disclosure, the pressure applied to the coenzyme solution to be purified is typically of between 4 and 35 bar. In a preferred embodiment, the pressure applied is of between 4 and 20 bar.

The diafiltration makes it possible to recirculate the solution containing the retentate, in order to eliminate the undesirable small molecules present in the retentate, by means of washing, and thus to improve the purity of the coenzymes.

The method is advantageously carried out continuously, which makes it possible to purify and then concentrate the coenzyme. This also makes it possible to use little solvent and to reuse it (recycling).

Thus, in a particular embodiment in which the method makes it possible to purify the CoA dimer, the CoA and the NADP⁺, the conditions are as follows: the membrane used is made of PES polymer or a material similar to polyamide (modified polyamide) to which a pressure of between 4 and 20 bar is applied, and the diafiltration is carried out continuously, using deionized water.

In a particular embodiment of the disclosure, the membrane is made of PES polymer, and a pressure of 20 bar is applied.

In a preferred embodiment of the disclosure, the membrane is made of modified polyamide, and a pressure of 4 bar is applied.

The coenzyme A dimer treated by the method according to the disclosure can be purified to at least 83%. In a particular embodiment, it is purified to 88%, 90%, 95%, or indeed 98% or 99%.

The coenzyme A treated by the method according to the disclosure can be purified to at least 45%. In a particular embodiment, it is purified to 88%, 90%, 95%, or indeed 98% or 99%.

The NADP⁺ treated by the method according to the disclosure can be purified to at least 59%. In a particular embodiment, it is purified to 88%, 90%, 95%, or indeed 98% or 99%.

The method according to the disclosure makes it possible to have access to high molecular weight adenosine-based coenzymes in large quantities and at a reasonable price, by means of an ecological and industrially viable method. This method thus opens the path to high-potential new markets.

### EXAMPLES

### Example 1: Study of the Effect of Different Membranes on the Separation of (CoAS)₂ Molecules by Means of Tangential Filtration

A reference scale was first implemented in HPLC with 85% commercial CoAS₂ at different concentrations, in order to be able to precisely measure the amount of the target molecule in the different fractions of the purification method (feed, retentate, permeate). The results obtained are set out in FIG. 2.

A medium containing (CoAS)₂, adenosine triphosphate (ATP), adenosine diphosphate (ADP), and adenosine monophosphate (AMP), in a final volume of 700 ml milli-Q water, was used to carry out the screening of the membranes.

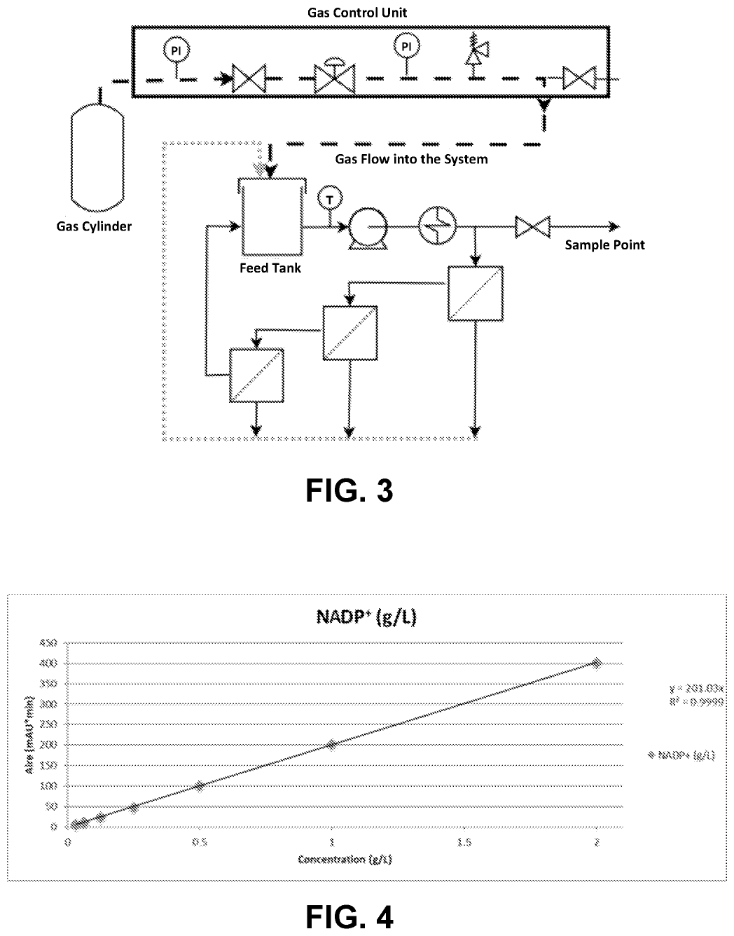

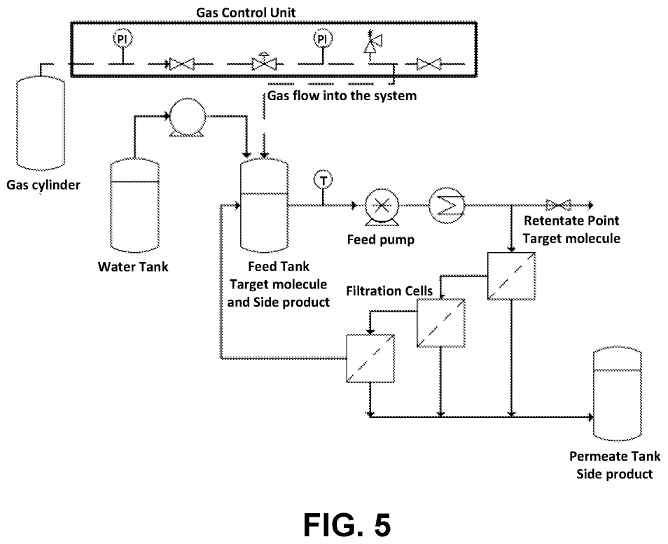

A tangential membrane filtration technique was investigated, in order to separate the molecules present in the mixture. Different types of commercial membranes: NP010, GE, GH, GK, GR15PP, HydraCore50-PS 7450 and HydraCore70pHT Series 7470PHT (Table 1), were studied according to a closed-circuit tangential configuration (FIG. 3).

The features of the membranes studied, as described by the suppliers, are summarized in Table 1.

TABLE 1
Main properties of the membranes studied

| | | | Cut-off | pH | Maximum |
|---|---|---|---|---|---|
| Manufacturer | Type | Membrane | (Da) | range | pressure |
| Suez | UF | GE | 900 for | 1-11 | 40 bar |
| | | | PEG | | |
| | UF | GH | 1400 for | 1-11 | 27 bar |
| | | | PEG | | |
| | UF | GK | 1500 for | 1-11 | 27 bar |
| | | | PEG | | |
| Microdyn- | NF | NP010 | 1000 | 0-14 | 40 bar |
| Nadir | | | | | |
| Alfa Laval | UF | GR95PP | 2000 | 1-13 | 10 bar |
| Hydronautics- | UF | HydraCore50-PS7450 | 1000 | 2-11 | 41 bar |
| Nitto | NF | HydraCore70pHT | 720 | 1-13.5 | 41 bar |
| | | Series 7470PHT | | | |

Four different pressures were studied, depending on the maximum pressure that can be applied to each membrane (according to the manufacturer's recommendations). The percentage retention of the different compounds, for each pressure and membrane, was calculated according to the following equation:

Retention_{compound}=(1−C_{p compound}/C_{r compound})×100

where C_{p compound} and C_{r compound} are, respectively, the concentrations of the compound studied, in the permeate and the retentate.

The results obtained at a given time are shown in Table 2, below.

The best results were obtained using the membrane GK, i.e., using a membrane made of modified polyamide, which has a cut-off of 1500 Da for PEG, and which can be used at a pH of between 1 and 11. The maximum pressure recommended for this membrane is 27 bar. The differential retention of (CoAS)₂ is at a maximum at 4 bar, but also very satisfactory at the other pressures tested, i.e., up to 10 bar.

The other membrane that allows for purification of (CoAS)₂ is the membrane NOP10, i.e., a membrane made of a polymer of the polyethersulfone (PES) type, which has a cut-off of 1000 Da and which can be used at a maximum pressure of 40 bar. The best result was obtained at a pressure of 20 bar.

### Example 2: Study of the Effect of Different Membranes on the Separation of CoA Molecules by Means of Tangential Filtration

A solution containing CoA, adenosine triphosphate (ATP), adenosine diphosphate (ADP), adenosine monophosphate (AMP), and 2-mercaptoethanol, in a final volume of 700 ml milli-Q water, was used for carrying out screening of the membranes.

A tangential membrane filtration technique was investigated, in order to separate the molecules present in the mixture. Different types of membrane: GE, GH, GK were studied according to a closed-circuit tangential configuration (FIG. 3).

The features of the membranes studied are summarized in Table 1.

Four different pressures were studied, depending on the maximum pressure that can be applied to each membrane (according to the manufacturer's recommendations). The percentage retention of the different compounds, for each pressure and membrane, was calculated according to the following equation:

Retention_{compound}=(1−C_{p compound}/C_{r compound})×100

where C_{p compound} and C_{r compound} are, respectively, the concentrations of the compound studied, in the permeate and the retentate.

The results obtained at a given time are shown in Table 3, below.

The best results were obtained using the membrane GK, i.e., using a membrane made of modified polyamide, which has a cut-off of 1500 Da for PEG, and which can be used at a pH of between 1 and 11. The maximum pressure recommended for this membrane is 27 bar. The differential retention of CoA is at a maximum at 4 bar, but also very satisfactory at the other pressures tested, i.e., up to 10 bar.

### Example 3: Study of the Effect of Different Membranes on the Separation of NADP⁺ Molecules by Means of Tangential Filtration

A reference scale was first implemented in HPLC with 98% commercial NADP⁺ at different concentrations, in order to be able to precisely measure the amount of the target molecule in the different fractions of the purification method (feed, retentate, permeate). The results obtained are set out in FIG. 4.

A solution containing NADP⁺, adenosine triphosphate (ATP), adenosine diphosphate (ADP), and adenosine monophosphate (AMP), in a final volume of 700 ml milli-Q water, was used to carry out the screening of the membranes.

A tangential membrane filtration technique was investigated, in order to separate the molecules present in the mixture. Different types of membrane: GE, GH, GK were studied according to a closed-circuit tangential configuration (FIG. 3).

The features of the membranes studied are summarized in Table 1.

Four different pressures were studied, depending on the maximum pressure that can be applied to each membrane (according to the manufacturer's recommendations). The percentage retention of the different compounds, for each pressure and membrane, was calculated according to the following equation:

Retention_{compound}=(1−C_{p compound}/C_{r compound})×100

where C_{p compound} and C_{r compound} are, respectively, the concentrations of the compound studied, in the permeate and the retentate.

The results obtained at a given time are shown in Table 4, below.

The best results were obtained using the membrane GK, i.e., using a membrane made of modified polyamide, which has a cut-off of 1500 Da for PEG, and which can be used at a pH of between 1 and 11. The maximum pressure recommended for this membrane is 27 bar. The differential retention of NADP⁺ is at a maximum at 4 bar, but also very satisfactory at the other pressures tested, i.e., up to 10 bar.

### Example 4: Separation of (CoAS)₂ Molecules by Means of Tangential Dia-Ultrafiltration

Tangential dia-ultrafiltration (FIG. 4) was carried out using a feed solution containing (CoAS)₂, ATP, ADP and AMP, in a final volume of 200 ml milli-Q water. The purity of the starting solution in terms of (CoAS)₂ is 45%.

The membrane used is GK, i.e., using a membrane made of modified polyamide, which has a cut-off of 1500 Da for PEG, and which can be used at a pH of between 1 and 11.

The washing solution is deionized water.

The expected losses and purities are predicted by the following equation, where C_{R,i,t} is the concentration in the retentate of each type i in solution at time t, where C_{A,i,0} is the concentration in the feed of each type i in solution at time t=0, where Rᵢ is the retention rate of each type i in solution (between 0 and 1), where V₀ is the feed volume, and where Vₜ is the volume of washing solution over time:

C_{R,i,t}/C_{A,i,0}=e^{(-(1-R}^{ᵢ}^{)×V}^{ₜ}^{/V}^{₀}⁾

The losses are calculated using the following equation, where C_{A,i,0} is the concentration in the feed of each type i in solution at time t=0, where C_{R,i,t} is the concentration in the retentate of each type i in solution at time t:

Lossesᵢ(%)=((C_{A,i,0}−C_{R,i,t})/C_{A,i,0})×100

The purity is calculated using the following equation, where C_{R,i,t} is the concentration in the retentate of each type i in solution at time t, and i, j, k, etc., are the types in solution:

Purityᵢ(%)=(C_{R,i,t}/(C_{R,i,t}+C_{R,j,t}+C_{R,k,t}))×100

A diafiltration volume (VD) corresponds to the feed volume.

The feed solution was washed using a VD of 5, with a membrane surface area of 39 cm². 88% of the ATP, 89% of the ADP, and 100% of the AMP were eliminated, in order to obtain a (CoAS)₂ purity of equal to 83%. The final purity is a relative value that depends on the initial purity and the number of washes.

Since the permeability is the capacity of a membrane to allow a solution to pass through, this was evaluated for deionized water before and after the dia-ultrafiltration.

The permeability Lₚ(L/h/m²/bar) to water was calculated according to the following formula, where Jᵥ is the flow of water (L/h/m²), P is the pressure applied to the system at the intake (bar), Vₚ is the permeate volume, t is a time interval (h), and S is the surface area of the membrane (m²):

Lₚ=Jᵥ/P where Jᵥ=Vₚ/(t×S)

The difference in permeability to water before and after the dia-ultrafiltration was less than 1%, the feed solution of the dia-ultrafiltration has not, therefore, blocked the membrane, which can be reused.

### Example 5: Separation of CoA Molecules by Means of Tangential Dia-Ultrafiltration

Tangential dia-ultrafiltration (FIG. 3) was carried out using a feed solution containing CoA, ATP, ADP, AMP and 2-mercaptoethanol, in a final volume of 200 ml milli-Q water. The purity of the starting solution in terms of CoA is 13%.

The membrane used is GK, i.e., using a membrane made of modified polyamide, which has a cut-off of 1500 Da for PEG, and which can be used at a pH of between 1 and 11.

The washing solution is deionized water.

The expected losses and purities are predicted by the following equation, where C_{R,i,t} is the concentration in the retentate of each type i in solution at time t, where C_{A,i,0} is the concentration in the feed of each type i in solution at time t=0, where Rᵢ is the retention rate of each type i in solution (between 0 and 1), where V₀ is the feed volume, and where Vₜ is the volume of washing solution over time:

C_{R,i,t}/C_{A,i,0}=e^{(-(1-R}^{ᵢ}^{)×V}^{ₜ}^{/V}^{₀}⁾

The losses are calculated using the following equation, where C_{A,i,0} is the concentration in the feed of each type i in solution at time t=0, where C_{R,i,t} is the concentration in the retentate of each type i in solution at time t:

Lossesᵢ(%)=((C_{A,i,0}−C_{R,i,t})/C_{A,i,0})×100

The purity is calculated using the following equation, where C_{R,i,t} is the concentration in the retentate of each type i in solution at time t, and i, j, k, etc., are the types in solution:

Purityᵢ(%)=(C_{R,i,t}/(C_{R,i,t}+C_{R,j,t}+C_{R,k,t}))×100

A diafiltration volume (VD) corresponds to the feed volume.

The feed solution was washed using a VD of 4, with a membrane surface area of 39 cm². 54% of the ATP, 56% of the ADP, 67% of the AMP, and 97% of the 2-mercaptoethanol were eliminated, in order to obtain a CoA purity of equal to 45%. The final purity is a relative value that depends on the initial purity and the number of washes.

Since the permeability is the capacity of a membrane to allow a solution to pass through, this was evaluated for deionized water before and after the dia-ultrafiltration.

The permeability Lₚ (L/h/m²/bar) to water was calculated according to the following formula, where Jᵥ is the flow of water (L/h/m²), P is the pressure applied to the system at the intake (bar), Vₚ is the permeate volume, t is a time interval (h), and S is the surface area of the membrane (m²):

Lₚ=Jᵥ/P where Jᵥ=Vₚ/(t×S)

The difference in permeability to water before and after the dia-ultrafiltration was less than 10%, the feed solution of the dia-ultrafiltration has not, therefore, blocked the membrane, which can be reused.

### Example 6: Separation of NADP⁺ Molecules by Means of Tangential Dia-Ultrafiltration

Tangential dia-ultrafiltration (FIG. 3) was carried out using a feed solution containing NADP⁺, ATP, ADP and AMP, in a final volume of 200 ml milli-Q water. The purity of the starting solution in terms of NADP⁺ is 52%.

The membrane used is GK, i.e., using a membrane made of modified polyamide, which has a cut-off of 1500 Da for PEG, and which can be used at a pH of between 1 and 11.

The washing solution is deionized water.

The expected losses and purities are predicted by the following equation, where C_{R,i,t} is the concentration in the retentate of each type i in solution at time t, where C_{A,i,0} is the concentration in the feed of each type i in solution at time t=0, where Rᵢ is the retention rate of each type i in solution (between 0 and 1), where V₀ is the feed volume, and where Vₜ is the volume of washing solution over time:

C_{R,i,t}/C_{A,i,0}=^{(-(1-R}^{ᵢ}^{)×V}^{ₜ}^{/V}^{₀}⁾

The losses are calculated using the following equation, where C_{A,i,0} is the concentration in the feed of each type i in solution at time t=0, where C_{R,i,t} is the concentration in the retentate of each type i in solution at time t:

Lossesᵢ(%)=((C_{A,i,0}−C_{R,i,t})/C_{A,i,0})×100

[OM] The purity is calculated using the following equation, where C_{R,i,t} is the concentration in the retentate of each type i in solution at time t, and i, j, k, etc., are the types in solution:

Purityᵢ(%)=(C_{R,i,t}/(C_{R,i,t}+C_{R,j,t}+C_{R,k,t}))×100

A diafiltration volume (VD) corresponds to the feed volume.

The feed solution was washed using a VD of 7, with a membrane surface area of 39 cm². 50% of the ATP, 47% of the ADP, and 93% of the AMP were eliminated, in order to obtain a NADP⁺ purity of equal to 59%. The final purity is a relative value that depends on the initial purity and the number of washes. Although in this case the increase in purity is small, this result nonetheless demonstrates the possibility of purifying the NADP⁺. The purity can be improved by optimization, for example, by increasing the number of washes.

Since the permeability is the capacity of a membrane to allow a solution to pass through, this was evaluated for deionized water before and after the dia-ultrafiltration.

The permeability Lₚ (L/h/m²/bar) to water was calculated according to the following formula, where Jᵥ is the flow of water (L/h/m²), P is the pressure applied to the system at the intake (bar), Vₚ is the permeate volume, t is a time interval (h), and S is the surface area of the membrane (m²):

Lₚ=Jᵥ/P where Jᵥ=Vₚ/(t×S)

The difference in permeability to water before and after the dia-ultrafiltration was less than 10%, the feed solution of the dia-ultrafiltration has not, therefore, blocked the membrane, which can be reused.

1. A method for purifying a high molecular weight adenosine-based coenzyme comprising implementing a tangential diafiltration of a solution comprising the high molecular weight adenosine-based coenzyme.

2. The method of claim 1, wherein the solution comprises an aqueous washing solution or any other aqueous buffer solution.

3. The method of claim 2, wherein the solution comprises deionized water.

4. The method of claim 3, wherein the diafiltration is a tangential dia-ultrafiltration.

5. The method of claim 4, wherein the high molecular weight adenosine-based coenzyme is coenzyme A disulfide ((CoAS)₂), coenzyme A (CoA) or a derivative thereof, or nicotinamide adenine dinucleotide phosphate (NADP⁺).

6. The method of claim 5, wherein the high molecular weight adenosine-based coenzyme comprises a derivative of coenzyme A having a formula (I): 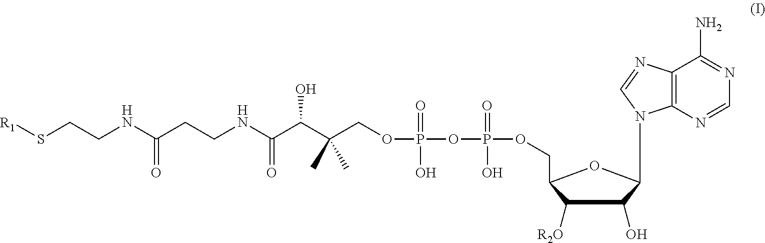
in which:
R₁ represents a C₁ to C₂₂ linear, cyclic or branched, saturated or unsaturated, acyl group, with or without a carboxylic acid, alcohol and/or amine group in a terminal position, or branched; a C₁ to C₂₂ linear, cyclic or branched, saturated or unsaturated, alkyl group, with or without a carboxylic acid, alcohol and/or amine group in the terminal position, or branched; a benzoyl or benzyl group; and
R₂ represents an H or a phosphate group.

7. The method of claim 6, wherein the tangential diafiltration involves separating a permeate from a retentate using a membrane comprising a polyethersulfone (PES) polymer or a membrane comprising a modified polyamide polymer.

8. The method of claim 7, further comprising applying a pressure to the solution adjacent the membrane during the diafiltration, the pressure being between 4 and 20 bar.

9. The method of claim 1, wherein the diafiltration is a tangential dia-ultrafiltration.

10. The method of claim 1, wherein the high molecular weight adenosine-based coenzyme is coenzyme A disulfide ((CoAS)₂), coenzyme A (CoA) or a derivative thereof, or nicotinamide adenine dinucleotide phosphate (NADP⁺).

11. The method of claim 10, wherein the high molecular weight adenosine-based coenzyme comprises a derivative of coenzyme A having a formula (I): 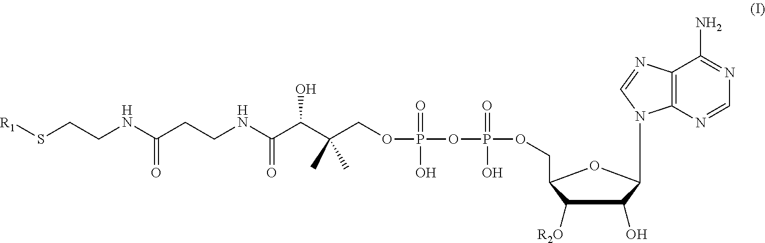
in which:
R₁ represents a C₁ to C₂₂ linear, cyclic or branched, saturated or unsaturated, acyl group, with or without a carboxylic acid, alcohol and/or amine group in a terminal position, or branched; a C₁ to C₂₂ linear, cyclic or branched, saturated or unsaturated, alkyl group, with or without a carboxylic acid, alcohol and/or amine group in the terminal position, or branched; a benzoyl or benzyl group; and
R₂ represents an H or a phosphate group.

12. The method of claim 1, wherein the tangential diafiltration involves separating a permeate from a retentate using a membrane comprising a polyethersulfone (PES) polymer or a membrane comprising a modified polyamide polymer.

13. The method of claim 1, wherein the tangential diafiltration involves separating a permeate from a retentate using a membrane, and wherein the method further comprises applying a pressure to the solution adjacent the membrane during the tangential diafiltration, the pressure being between 4 and 20 bar.
